(19) United States
(12) Patent Application Publication
(10) Pub. No.: US 2005/0210311 A1
(43) Pub. Date: Sep. 22, 2005

(54) Method and system for probabilistic defect isolation

(76) Inventor: Thomas L. Rodeheffer, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/797,499

(22) Filed: Mar. 8, 2004

(51) Int. Cl. G06F 11/00

(52) U.S. Cl. 714/1

(57) ABSTRACT

A method and system for probabilistic defect isolation in a set that comprises a plurality of resources, each resource in the plurality of resources having at least one characteristic, each resource in the plurality of resources being defined to be good if the characteristic of that resource meets a predetermined criterion and being otherwise defined to be bad. The method comprises assigning to each resource in a group of the plurality of resources an initial probabilistic estimate of the likelihood that that resource is good. The method also comprises assigning a probabilistic estimate of the likelihood that the group of the plurality of resources might accidentally pass the test and iteratively performing the test on various groups of the plurality of resources. Further, the method comprises determining a probabilistic estimate that each of the resources in the group of the plurality of resources is good based on the performance of the test on the group of the plurality of resources.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

A system may comprise a number of resources, some of which may be defective. For example, a system may be a computer that comprises a number of electronic chips. The chips are resources of the computer system, and some of the chips may be defective. Accordingly, it may be desirable or even necessary to test the system to determine which resources are functional (good) and which resources are inoperative (bad). In another example, a single electronic chip may be the system, and a number of logic devices on the chip may be the resources. In this second example, it may be desirable to perform a test or tests to determine which, if any, of the logic devices are good and which logic devices are bad.

One method of determining the status of system resources, as in the examples above, may be to test each resource in the system individually. However, individualized testing may not always be possible or efficient. For example, some systems may prohibit such testing based on the structure of the system. Other systems may comprise too many resources to efficiently test each resource individually. Accordingly, it may be desirable or even necessary to test some systems by testing groups of resources within the system thus reducing the number of tests required. For example, if a system contains one hundred resources, the system may be tested by first dividing the system into five groups of twenty resources, reducing the number of tests from one-hundred to five. Next, each of the five groups may be tested to determine whether the group as a whole is good or bad. The group is defined as good if all of its resources are good. If any resource is bad, the group is defined as bad.

However, inherent problems exist with the abovementioned method of testing groups. Further, there exists difficulty in selecting groups with a reasonable likelihood of providing a positive outcome based on initial estimates or based on information obtained from prior testing. For example, if twenty electrical components are tested as a group and the test fails, the test may not indicate which of the twenty components is/are faulty. This inherent difficulty exists because one bad component can cause the entire group to fail and thus cause the group to be deemed bad. Accordingly, it may be necessary to choose groups wherein all the resources comprised by the group are good. This necessity arises because negative tests only indicate that at least one resource in the group is faulty, and good groups may be necessary in order to obtain valid results regarding the status of resources in a system. However, it may be difficult to select groups that have a reasonable likelihood of producing a success when tested. Additionally, a further problem exists in that even a positive test may not be a true indication that all twenty components are good. There may be some probability of an accidental success.

Faulty information may result from tests that yield incorrect results due to accidental successes. This faulty information can be very problematic. For example, a group may be deemed good when in actuality it contains a bad resource. A falsely positive test result can damage or reduce the value of an entire system or network of systems. One means of overcoming the problem of accidental successes is to employ a stronger test, one which has less likelihood of producing an accidental success. However, the number and complexity of resources in a group may limit the strength of a test of that group. One means to employ stronger tests is to increase the number of resources in each group. By making the group contain more resources, it may be possible to employ a test strong enough that the probability of achieving an accidental success is negligible. However, by increasing the number of resources in each group, it becomes even more difficult to select groups which will with reasonable probability provide a positive or good test. Very simply, the increase in the difficulty of selecting good groups is due to an increase in the probability of each group containing at least one bad resource. Of course, the probability of failure increases proportionally relative to the defect rate of resources in the particular system. This is due to the increased likelihood of including a bad resource. Thus, in systems with defect rates above a certain level, it may not be practical to overcome the problem of accidental successes by increasing the group size.

### BRIEF DESCRIPTION OF THE DRAWINGS

Advantages of one or more disclosed embodiments may become apparent upon reading the following detailed description and upon reference to the drawings in which:

FIG. 1 is a block diagram that illustrates a method of isolating defects in a system or set of resources through testing in accordance with embodiments of the present invention;

FIG. 2 is a directed graph representing a system comprising a number of resources in accordance with embodiments of the present invention;

FIG. 3 is a block diagram that illustrates a method of selecting groups of resources for testing in accordance with embodiments of the present invention; and

FIG. 4 is a block diagram that illustrates a computer system for isolating defects in a set of resources through testing in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present invention may provide the ability to test resource characteristics and/or resources of a system for which individual testing is either impractical due to the number of resources comprised by the system, or impossible because of inaccessibility. Further, embodiments of the present invention may account for accidental successes, thus allowing for division of systems into relatively small groups. Because accidental successes may be taken into account, the groups need not be so large as to negate the possibility of accidental success. Additionally, by allowing relatively small groups, the probability of choosing good groups (groups that will return positive results or that will pass) may increase. Accordingly, even systems with high defect rates, which require smaller groups in order to acquire positive tests, may be reliably testable utilizing embodiments of the present invention.

It should also be noted that embodiments of the present invention may provide means for selecting groups with higher probabilities of success. In other words, the present invention may provide information or a system for choosing good groups, thus increasing the probability of acquiring useful information. This may be beneficial because failed tests are not fair or adequate tests for good resources in a group. For example, failed (negative) tests only indicate that at least one resource is bad. Good resources can only demonstrate that they are good through successful (positive) tests. Thus, positive tests provide the best and most valuable information.

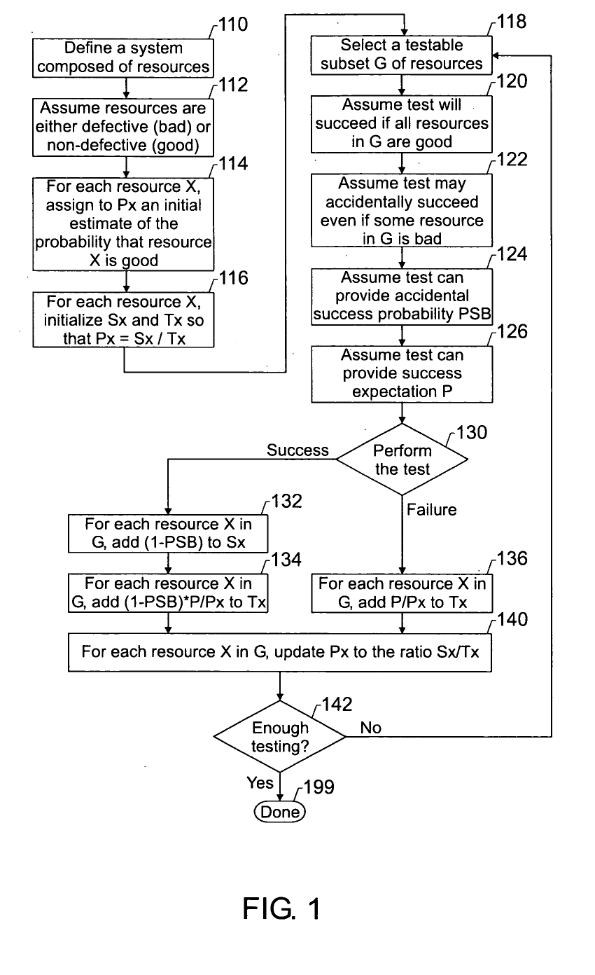

FIG. 1 is a block diagram that illustrates a method of isolating defects in a system or set of resources through testing in accordance with embodiments of the present invention. Specifically, FIG. 1 illustrates a testing strategy and method for identifying the likelihood that any particular resource is good. In other words, FIG. 1 illustrates one embodiment of a method for probabilistic defect isolation.

In accordance with FIG. 1, embodiments of the present invention may comprise testing a system composed of a number of resources, some of which may be defective, such as the system defined in block 110. Each resource may then be assumed to be either defective (bad) or non-defective (good), as shown in block 112.

Embodiments of the present invention may comprise an iterative method for estimating a probability “Px” that X is good, where X is a resource. The iterative method may begin with an initial estimate of Px for each resource X, as shown in block 114, based on the nature of the system and the nature of the resource. Considering the resource X, this method includes counting a number of successes “Sx” and tests “Tx” for X. As shown in block 116, Sx and Tx may initially be set so that their ratio Sx/Tx equals Px. The iterative method may select a testable group of resources, as shown in block 118, perform a test, and update the counts of successes and tests for the resources in the group. The ratio of Sx to Tx (Sx/Tx) may then be calculated to give a revised estimate for the probability Px. It should be noted that the tests and successes are not counted as integers, but rather as summations of probabilities based on the results of the group tests in which X has been involved. For example, a group may comprise three resources (X₁, X₂, X₃). Based on previous tests, the probability that X₁ is good may be estimated as 0.9, the probability that X₂ is good may be estimated as 0.9, and the probability that X₃ is good may be estimated as 0.1. A test of this group of three resources may be expected to succeed with probability 0.081, assuming that the test depends uniformly on all three resources. In other words, this test may be expected to fail. But it would not be fair to attribute much of the cause for such a failure to X₁ or X₂, because the failure would be much more likely due to X₃. In particular, each resource may be seen as being tested only under the conditional probability that the other resources are good. For resource X₁, the probability that the other resources are good may be estimated as the product 0.9×0.1=0.09. Accordingly, after testing the example group and getting a failure, the fraction 0.09 would be added to the number of tests for X₁. The test is not very effective for resource X₁ because the failure is most likely the fault of the resource having only a ten percent likelihood of being good. For resource X₃, the probability that all the other resources are good may be estimated as the product 0.9×0.9=0.81. Accordingly, after testing the example group and getting a failure, the fraction 0.81 would be added to the number of tests for X₃. Similarly, if a success occurs, only the probability that the success was not accidental may be attributed to a success count. This probability that the success was not an accidental success is related to the probability of success with a bad element discussed below and depends on the particular test being used. The probability of success with a bad element may be referred to as “PSB.”

In testing a group involving resource X, several assumptions may be made. An assumption may be that the test will always succeed if all the resources in the group are good (block 120). Another assumption may be that if some resource in the group is bad, the test will usually fail, but it may accidentally succeed with some probability PSB (block 122). Another assumption may be that the test can indicate the value of the probability PSB, based on its internal structure (block 124). For example a test that expects never to produce an accidental success, would indicate that PSB=0. Another example is a full-sequence linear-feedback shift register of n bits, which in spite of containing a bad resource has a probability of roughly 2⁻ⁿ of accidental success after being clocked for many cycles.

Another assumption is that the test can tell us, based on the internal structure of the test and the estimated probabilities of the resources in the group, the expectation P that the test will succeed (block 126). If the test depends uniformly on all of the resources in the group, then P could be the product of Py over all resources Y in the group. This would assume that all of the probability estimates are independent. This could be a default assumption, because a well-designed test should depend uniformly on all of its resources. However, tests that depend more heavily on some resources than others may still be used with this method by making a proper calculation of the expectation P.

In the illustrated embodiment, the test is performed, as shown in block 130. If the test succeeds, for each resource X in the group, the number of successes Sx is increased by 1-PSB and the number of tests Tx is increased by (1−PSB)×P/Px (blocks 132 and 134). If the test fails, for each resource X in the group, the number of tests Tx is increased by P/Px and the number of successes is left unchanged (block 136). With the updated information, the estimated probability Px for each resource X in the group is recalculated as illustrated in block 140. The iteration proceeds through block 142 back to block 118 to select another testable group of resources. When enough testing has been performed, the method is finished (block 199).

Other embodiments can be envisaged comprising similar versions of the calculations presented in blocks 114-142 that may also function with the present invention. For example, on a successful test, the number of tests Tx could be increased by P/Px and the number of successes Sx could be increased by 1−PSB.

In summary, there may be two general concepts concerning attributing fractional test results. The first concept is to attribute a fractional test to each resource X based on how strongly the state of that resource X influenced the test result. The second concept is to attribute a fractional success to each resource X based on how strongly the test result indicates that the resource X must be good. It should be noted that different numerical calculations that follow this concept may tend to provide an acceptable result, even if the exact conditional probability calculation is not mathematically accurate. In the present context, an acceptable result may be defined such that after iteration of many tests, the probability estimates for each resource tend to discriminate between good resources and bad resources. In other words, rough approximations may be sufficient, which is beneficial because getting an exact probability model of the dependence of a test on its resources is often quite difficult.

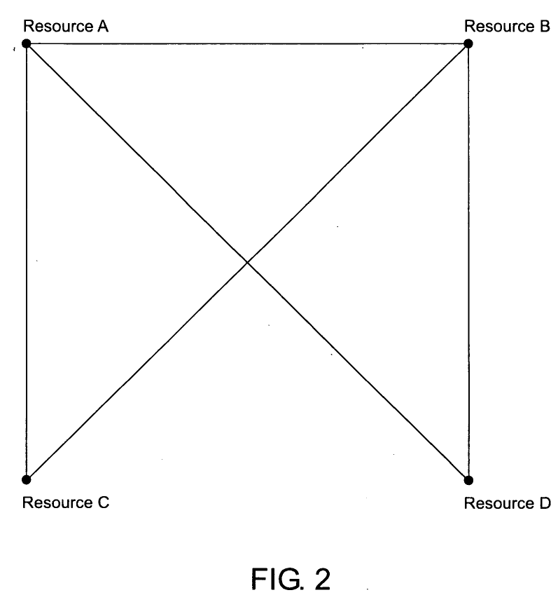

FIG. 2 is a graph representing a system comprising a number of resources in accordance with embodiments of the present invention. To get the most information from each test, it is beneficial to select groups for testing such that the expectation of success P for the group is about 0.5. In embodiments of the present invention, a sequence of adjacent resources may form a test group. For example, the test group may comprise linear feedback shift registers (horizontal and vertical paths in a matrix) or paths through a network. The system may be represented as a graph, as illustrated in FIG. 2, whose nodes are the resources and edges encode the adjacency. For example, four nodes are illustrated wherein each node represents a resource. Resource A is adjacent Resources B, C, and D. However, Resources C and D are not adjacent one another. Accordingly, if the test requires adjacency, Resources C and D cannot alone comprise a testable group.

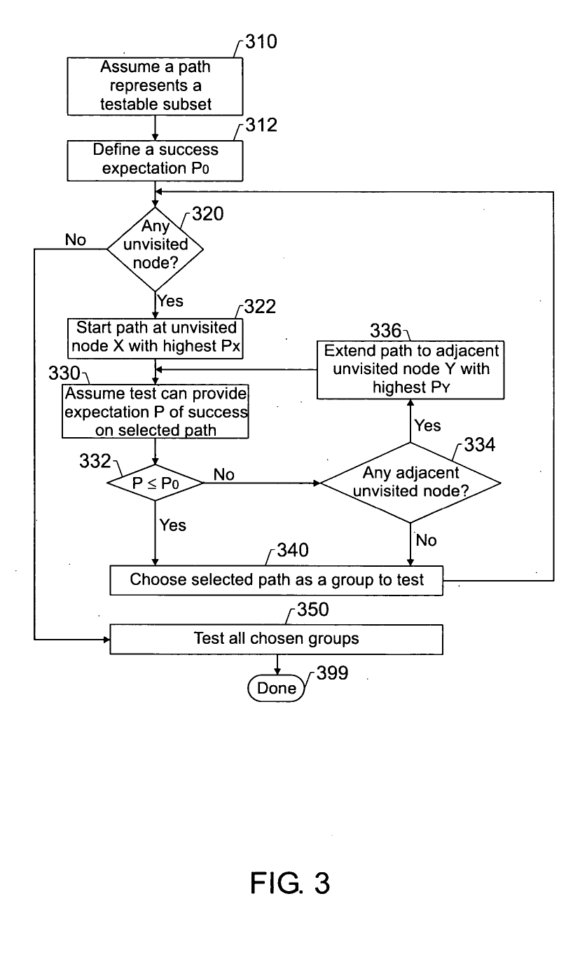

FIG. 3 is a block diagram that illustrates a method of selecting groups of resources for testing in accordance with embodiments of the present invention. As illustrated by block 310, it may be assumed that any path (of at least a minimum length) through a graph such as shown in FIG. 2 represents a group that can be tested. Although the illustrated embodiment assumes that any path represents a group that can be tested, it will be clear to those skilled in the art that this is just a specific example of an assumption that any connected subgraph, or any connected subgraph of a certain kind, represents a group that can be tested. A particular success expectation value P₀ may be defined such as 0.5 (block 312). Accordingly, a method of selecting a group for testing may begin anywhere in the graph (blocks 320 and 322) and the selection method may further comprise walking from node to node (never visiting the same node twice) (blocks 334 and 336) until the path forms a group whose test success expectation P, as calculated based on the most recent iteration (block 330), is less than or equal to the predefined value P₀ (block 332). This selection method may be referred to as the graph walking method.

In some embodiments, a large system may be tested in which many, non-overlapping groups may be configured. In such a system, tests may be performed and then evaluated utilizing the graph walking method, discussed above. For example, groups may be selected using the graph walking system. Further, this group selection process may be applied repeatedly to completion (block 399) or until all nodes have been visited and included into some group (blocks 320 and 340). Accordingly, all groups may be tested individually or in parallel (block 350). Even if the system does not allow for simultaneous tests, applying the graph walking method repeatedly until all nodes have been visited may be a good approach to get coverage.

When selecting the starting node for a path in the graph walking method, selecting the unvisited node with the highest probability for success, as illustrated by block 322, helps to select a larger group of nodes. Likewise, when selecting other nodes to extend a path (block 336), selecting the nodes with the highest probability of producing a successful test will also help to select a larger group of nodes. Larger groups permit more robust tests and thus have a lower chance of accidental success, which makes the information produced by a good test more valuable.

In some embodiments of the present invention, rather that keeping counts of successes (Sx) and tests (Tx), successes (Sx) and failures (Fx) could be tallied. In such a system, the number of tests (Tx) would just be the sum of the successes (Sx) and the failures (Fx).

In performing the tests and iterations discussed above, it may be beneficial to initialize all nodes to 0.5 successes (Sx) and one test (Tx). This would correspond to an initial probability estimate Px of 0.5. The process of choosing groups and testing the groups may be repeated iteratively until every (or most) nodes have accumulated a minimum number of tests. For example, the minimum number of tests may be set at twenty. As the iteration proceeds, nodes with a probability less than 0.45, for example, may be considered as bad and nodes with a probability of greater than 0.55 may be considered as good. Of course, these thresholds may be adjusted and such a procedure may continue until convergence, until certain values are reached, until users are satisfied, or until some other designated stopping point. Further, the results may be utilized in the identification of error prone nodes or bad nodes.

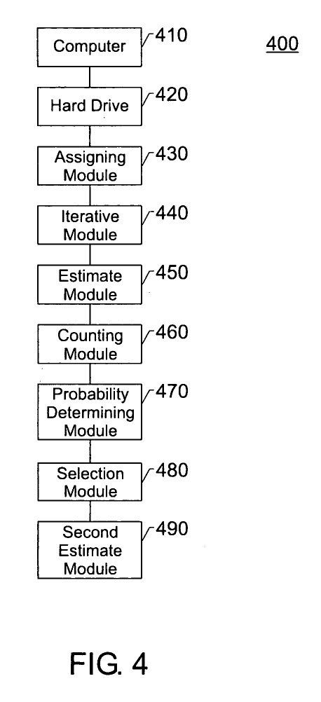

FIG. 4 is a block diagram that illustrates a computer system 400 for isolating defects in a set of resources through testing in accordance with embodiments of the present invention. As is illustrated, the computer system 400 may comprise various components and/or modules. The computer system 400 may combine these modules and/or components into single modules or components. Additionally, the computer system 400 may split the modules and/or components into sub-functions. Further, these modules and/or components may be implemented in hardware or software embodiments.

Specifically, the illustrated computer system 400 comprises a computer and a hard drive which are represented by blocks 410 and 420 respectively. The computer system 400 may also comprise various other modules, as illustrated in FIG. 4. Block 430 of FIG. 4, for example, represents an assigning module that may be adapted to assign to each resource in a group of the plurality of resources an initial probabilistic estimate of the likelihood that each of the resources in the group of the plurality of resources is good. FIG. 4 also illustrates an iterative module (block 440) that may be adapted to iteratively perform a test on various groups of the plurality of resources. For example, the iterative module (block 440) may allow for convergence to a probability Px that the resource X is good, as discussed previously. FIG. 4 also illustrates an estimate module in block 450. The estimate module (block 450) may be adapted to determine a probabilistic estimate that each of the resources in the group of the plurality of resources is good based on the performance of the test on the group of the plurality of resources and based on a probabilistic estimate of the likelihood that the group of the plurality of resources might accidentally pass the test.

Other modules represented in FIG. 4 are: a counting module (block 460), a probability determining module (block 470), a selection module (480), and a second estimate module (490). The counting module (block 460) may be adapted to count a number of iterative tests and a number of particular test outcomes, as discussed previously. The probability determining module (block 470) may be adapted for determining the probabilistic estimate of the likelihood that the group of the plurality of resources might accidentally pass the test. The selection module (block 480) may be adapted for selecting resources such that a probabilistic value of an outcome of the performance of the test approximately equals a value. Finally, the second estimate module (490) may be adapted to determine the probabilistic estimate of the likelihood that the group of the plurality of resources might accidentally pass the test.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A method of probabilistic defect isolation in a system, comprising:
identifying a plurality of resources, each resource in the plurality of resources having at least one characteristic, each resource in the plurality of resources being defined to be good if the characteristic of that resource meets a predetermined criterion and being otherwise defined to be bad;
defining a test to apply to a group of the plurality of resources, wherein the test is defined to be passed if each resource in the group of the plurality of resources to which the test is applied is good;
assigning to each resource in the group of the plurality of resources an initial probabilistic estimate of the likelihood that that resource is good;
assigning a probabilistic estimate of the likelihood that the group of the plurality of resources might accidentally pass the test;
iteratively performing the test on various groups of the plurality of resources; and
determining a probabilistic estimate that each of the resources in the group of the plurality of resources is good based on the performance of the test on the group of the plurality of resources.

2. The method of claim 1, comprising counting a number of iterative tests and a number of particular test outcomes.

3. The method of claim 2, comprising counting a number of successful test outcomes.

4. The method of claim 2, comprising determining the probabilistic estimate that each of the resources in the group of the plurality of resources is good by determining a ratio of the number of iterative tests and the number of particular test outcomes.

5. The method of claim 2, comprising counting the number of iterative tests and the number of particular test outcomes as summations of probabilities.

6. The method of claim 1, comprising counting a number of iterative tests by increasing the number of iterative tests for each iterative test by a value based on the probabilistic estimate of the likelihood that the group of the plurality of resources might accidentally pass the test.

7. The method of claim 1, comprising counting a number of particular test outcomes by increasing the number of particular test outcomes for each particular outcome by a value based on the probabilistic estimate of the likelihood that the group of the plurality of resources might accidentally pass the test.

8. The method of claim 1, comprising selecting resources such that a probabilistic value of an outcome of the performance of the test approximately equals a value.

9. The method of claim 1, comprising selecting resources using a graph walking system.

10. The method of claim 1, comprising determining the probabilistic estimate that each of the resources in the group of the plurality of resources is good based on the probabilistic estimate of the likelihood that the group of the plurality of resources might accidentally pass the test.

11. A system, comprising:
a set that comprises a plurality of resources, each of the plurality of resources having at least one characteristic, each of the plurality of resources being defined to be good if the characteristic of that resource meets a predetermined criterion and being otherwise defined to be bad;
means for assigning to each resource in a group of the plurality of resources an initial probabilistic estimate of the likelihood that each of the resources in the group of the plurality of resources is good;
means for iteratively performing a test on various groups of the plurality of resources; and
means for determining a probabilistic estimate that each of the resources in the groups of the plurality of resources is good based on the performance of the test on the groups of the plurality of resources and based on a probabilistic estimate of the likelihood that the group of the plurality of resources might accidentally pass the test.

12. The system of claim 11, comprising means for selecting resources such that a probabilistic value of an outcome of the performance of the test approximately equals a value.

13. The system of claim 11, comprising means for determining the probabilistic estimate of the likelihood that the group of the plurality of resources might accidentally pass the test.

14. A computer program for probabilistic defect isolation in a system, comprising:
a tangible medium;
an assigning module stored on the tangible medium, the assigning module being adapted to assign to each resource in a group of a plurality of resources an initial probabilistic estimate of the likelihood that each of the resources in the group of the plurality of resources is good, the resource being defined to be good if a characteristic of that resource meets a predetermined criterion and being otherwise defined to be bad;
an iterative module stored on the tangible medium the iterative module being adapted to iteratively perform a test on various groups of the plurality of resources; and
an estimate module stored on the tangible medium the estimate module being adapted to determine a probabilistic estimate that each of the resources in the group of the plurality of resources is good based on the performance of the test on the group of the plurality of resources and based on a probabilistic estimate of the likelihood that the group of the plurality of resources might accidentally pass the test.

15. The computer program of claim 14, comprising a counting module stored on the tangible medium and adapted to count a number of iterative tests and a number of particular test outcomes.

16. The computer program of claim 15, comprising a probability determining module stored on the tangible medium adapted for determining the probabilistic estimate that each of the resources in the group of the plurality of resources is good by determining a ratio of the number of iterative tests and the number of particular test outcomes.

17. The computer program of claim 14, comprising a counting module stored on the tangible medium adapted for counting a number of iterative tests and a number of particular test outcomes as summations of probabilities.

18. The computer program of claim 14, comprising a counting module stored on the tangible medium and adapted for counting a number of iterative tests by increasing the number of iterative tests for each iterative test by a value based on the probabilistic estimate of the likelihood that the group of the plurality of resources might accidentally pass the test.

19. The computer program of claim 14, comprising a counting module stored on the tangible medium adapted for counting a number of particular test outcomes by increasing the number of particular test outcomes for each particular outcome by a value based on the probabilistic estimate of the likelihood that the group of the plurality of resources might accidentally pass the test.

20. The computer program of claim 14, comprising a selection module stored on the tangible medium adapted for selecting resources such that a probabilistic value of an outcome of the performance of the test approximately equals a value.

21. The computer program of claim 14, comprising a second estimate module stored on the tangible medium being adapted to determine the probabilistic estimate of the likelihood that the group of the plurality of resources might accidentally pass the test.

22. A computer system for probabilistic defect isolation, comprising:
a computer;
an assigning module that is adapted to assign to each resource in a group of a plurality of resources an initial probabilistic estimate of the likelihood that each of the resources in the group of the plurality of resources is good, the resource being defined to be good if a characteristic of that resource meets a predetermined criterion and being otherwise defined to be bad;
an iterative module being adapted to iteratively perform a test on various groups of the plurality of resources; and
an estimate module being adapted to determine a probabilistic estimate that each of the resources in the group of the plurality of resources is good based on the performance of the test on the group of the plurality of resources and based on a probabilistic estimate of the likelihood that the group of the plurality of resources might accidentally pass the test.

23. The computer system of claim 22, comprising a counting module adapted to count a number of iterative tests and a number of particular test outcomes.

24. The computer system of claim 23, comprising a probability determining module adapted for determining the probabilistic estimate that each of the resources in the group of the plurality of resources is good by determining a ratio of the number of iterative tests and the number of particular test outcomes.

25. The computer system of claim 22, comprising a counting module adapted for counting a number of particular test outcomes by increasing the number of particular test outcomes for each particular outcome by a value of one minus the probabilistic estimate of the likelihood that the group of the plurality of resources might accidentally pass the test.

26. The computer system of claim 22, comprising a selection module adapted for selecting resources such that a probabilistic value of an outcome of the performance of the test approximately equals a value.

27. The computer system of claim 22, comprising a selection module adapted for selecting resources using a graph walking system.
